(19) United States
(12) Patent Application Publication
(10) Pub. No.: US 2025/0251742 A1
(43) Pub. Date: Aug. 7, 2025

(54) A CONTROL SYSTEM FOR CONTROLLING A FLEET OF AUTONOMOUS VEHICLES

(71) Applicant: Volvo Autonomous Solutions AB, Göteborg (SE)

(72) Inventors: Åsa ROGENFELT, Gothenburg (SE); Oskar NORESSON, Mölndal (SE); Gustaf JOHANSSON, Göteborg (SE)

(73) Assignee: Volvo Autonomous Solutions AB, Göteborg (SE)

(21) Appl. No.: 18/855,058

(22) PCT Filed: Apr. 12, 2022
(86) PCT No.: PCT/EP2022/059791

§ 371 Date: Oct. 8, 2024

(51) Int. Cl. G05D 1/693; G05D 1/633; G05D 107/13; G05D 109/10

(52) U.S. Cl. CPC G05D 1/693; G05D 1/633; G05D 2107/13; G05D 2109/10

(57) ABSTRACT

A control system controls a fleet of autonomous vehicles which are adapted to travel along driving paths in an area. The fleet of vehicles comprises at least two vehicles, each vehicle utilizes a first and a second driving behaviour when driving along a driving path. The first driving behaviour is associated with driving closer to an edge of a road section, in relation to the second driving behaviour, which is associated with driving further away from the edge and closer to a center line of the road section. The control system predicts if a meeting between the at least two vehicles along the road section will occur, and when it is predicted that the meeting will occur, command at least one of the at least two vehicles to utilize the first driving behaviour to thereby allow and/or facilitate for the vehicles to pass each other along the road section.

### TECHNICAL FIELD

The invention relates to a control system for controlling a fleet of autonomous vehicles. The invention also relates to an autonomous vehicle, a method for controlling a fleet of autonomous vehicles, a computer program and a computer readable medium.

The invention can be applied for heavy-duty vehicles, such as trucks, buses and construction equipment. Although the invention will be described with respect to an autonomous truck, the invention is not restricted to this particular vehicle, but may also be used for other vehicles such as buses, wheel loaders, dump trucks, excavators etc.

### BACKGROUND

It is known to control a fleet of autonomous vehicles which are operating in an area. For example, the fleet of autonomous vehicles may operate in a construction site, a mining area, a terminal area, a harbour, or any other type of confined area. The control may for example be performed from a central control center at the area.

The control of the vehicles may comprise issuing control instructions to the vehicles. The control instructions may be instructions to perform tasks, such as loading and/or unloading of goods/material, instructions to drive autonomously from one point to another point in the area, etc.

When the vehicles drive autonomously in the area, meetings between the vehicles along road sections are likely to occur. For example, when two vehicles are about to enter a relatively narrow road section while driving in opposite directions, one of the vehicles may be required to stop at a predefined meeting location to allow the other vehicle to pass by. Additionally, or alternatively, the vehicles may be programmed and/or instructed to always slow down at predefined meeting locations to allow the vehicles to safely pass by each other. For example, the predefined meeting locations may comprise parallel driving paths where the meeting vehicles drive slowly in a respective driving path until leaving the predefined meeting location. When the vehicles are not at the predefined meeting locations, a higher speed may be allowed.

In view of the above, there is a strive to improve control of a fleet of autonomous vehicles so that meetings between vehicles can be carried out in a more efficient and flexible manner.

### SUMMARY

An object of the invention is to provide an improved control system for controlling a fleet of autonomous vehicles, or at least to provide a suitable alternative. More specifically, an object of the invention is to provide a more efficient and flexible control system for controlling a fleet of autonomous vehicles. Other objects of the invention are to provide an improved autonomous vehicle, an improved method for controlling a fleet of autonomous vehicles, a computer program and a computer readable medium.

The object is at least partly achieved by a control system according to claim 1.

Hence, there is provided a control system for controlling a fleet of autonomous vehicles which are adapted to travel along driving paths in an area, wherein the fleet of vehicles comprises at least two vehicles, each vehicle being adapted to utilize a first and a second driving behaviour when driving along a driving path. The first and second driving behaviours are preferably predefined driving behaviours.

The first driving behaviour is associated with driving closer to an edge of a road section, in relation to the second driving behaviour, which is associated with driving further away from the edge and closer to a center line of the road section.

The control system is configured to:
by use of data indicative of driving status and position of the at least two vehicles, predict if a meeting between the at least two vehicles along the road section will occur, and
when it is predicted that the meeting will occur, command at least one, preferably each one, of the at least two vehicles to utilize the first driving behaviour to thereby allow and/or facilitate for the vehicles to pass each other along the road section.

The driving status data may typically comprise information indicative of vehicle speed.

The data indicative of position may typically comprise map data of the area.

By utilizing the first driving behaviour to thereby allow and/or facilitate for the vehicles to pass each other along the road section is herein meant that one of the vehicles will drive closer to one of the edges while the other vehicle will drive closer to a center line of the road section or closer to the other opposite edge of the road section.

By the provision of a control system as disclosed herein, a more flexible and/or efficient control of a fleet of autonomous vehicles is achieved. In particular, the vehicles may be allowed to utilize the second driving behaviour more often. Furthermore, the first driving behaviour may only be used when necessary, i.e. when a meeting occurs. Still further, by the present invention, vehicles may be allowed to pass by each other at any location along a road section, implying increased flexibility. The second driving behaviour, i.e. when driving closer to the center of a road section, is typically a driving behaviour which is associated with a higher productivity compared to the first driving behaviour. For example, when utilizing the second driving behaviour, navigational tolerances may be allowed to be larger compared to when utilizing the first driving behaviour. Larger navigational tolerances may imply higher allowed vehicle speed and/or reduced need of processing power for vehicle navigation. Still further, more frequent use of the second driving behaviour implies that the road wear at the edges of the road section will be reduced. Reduced road wear at the road edges implies that the road section will last for a longer time, reducing the need for road repair work. More specifically, road edges are typically more likely to be damaged when used frequently. This is especially common for non-asphalt roads, such as dirt roads, gravel roads etc. Accordingly, in one example embodiment, the area is an area comprising road sections in the form of gravel roads, dirt roads, etc., i.e. non-asphalt roads.

Optionally, commanding at least one, preferably each one, of the at least two vehicles to utilize the first driving behaviour comprises commanding at least one, preferably each one, of the at least two vehicles to switch from utilizing the second driving behaviour to instead utilize the first driving behaviour. Accordingly, the vehicle(s) may have utilized the more productive second driving behaviour before the meeting.

Optionally, switching from utilizing the second driving behaviour to instead utilize the first driving behaviour is configured to be performed at any position along the road section. Thereby, a more flexible control is achieved, implying that the first driving behaviour can be used for a shorter time. This in turn implies increased productivity.

Optionally, the control system is further configured to:
estimate a first required transition path along the road section for switching between the second driving behaviour to the first driving behaviour, wherein the first required transition path is estimated by use of a vehicle model which is based on physical properties of the at least one vehicle. Thereby, the required transition path can be optimized for the specific vehicle, implying a shorter transition path and/or a safer transition between the second and first driving behaviours when switching therebetween. By a shorter transition path, the second driving behaviour can be used more often, implying increased productivity. By way of example, the physical properties of the vehicle may be at least one of vehicle weight, vehicle length and/or width, wheelbase length and number of articulation joints.

Optionally, switching from utilizing the second driving behaviour to instead utilize the first driving behaviour is configured to be performed at a predetermined position along the road section. Still optionally, switching from utilizing the second driving behaviour to instead utilize the first driving behaviour is configured to be performed at any one of a plurality of predetermined positions along the road section. These approaches imply a facilitated control system which may require less processing power.

Optionally, the control system is further configured to:
by use of the data indicative of driving status and position, determine when the meeting has occurred, and therefrom:
command the at least one, preferably each one, of the at least two vehicles to switch from utilizing the first driving behaviour to instead utilize the second driving behaviour.

Thereby, the vehicles can immediately after the meeting return to the second driving behaviour. This implies increased productivity.

Optionally, switching from utilizing the first driving behaviour to instead utilize the second driving behaviour is configured to be performed at any position along the road section.

Optionally, the control system is further configured to:
estimate a second required transition path along the road section for switching between the first driving behaviour to the second driving behaviour, wherein the second required transition path is estimated by use of a vehicle model which is based on the physical properties of the at least one vehicle. As mentioned in the above, by optimizing the transition path, a shorter transition path and/or a safer transition between the first and second driving behaviours is achieved.

Optionally, switching from utilizing the first driving behaviour to instead utilize the second driving behaviour is configured to be performed at a predetermined position along the road section. Still optionally, switching from utilizing the first driving behaviour to instead utilize the second driving behaviour is configured to be performed at any one of a plurality of predetermined positions along the road section. These approaches imply a facilitated control system which may require less processing power.

Preferably, the second driving behavior for at least one, preferably each one, of the at least two vehicles is a default driving behaviour. By using the second driving behaviour as the default driving behaviour, i.e. the preferred behaviour which is used if nothing else is instructed by the control system, the productivity of the vehicles operating in the area can be increased. This also implies reduced wear of road edges, safer travelling by travelling in the center of the road section, reduced need of processing power for the navigation etc.

Optionally, at least one of the first and second driving behaviours is associated with predetermined driving paths in the area. Accordingly, the autonomous vehicles may navigate in the area by following the predetermined driving paths. By using predetermined driving paths, such as driving paths which have been pre-recorded by at least one autonomous vehicle and/or driving paths which have been predetermined manually or automatically by a computer, a more predictive and efficient driving in the area can be achieved. For example, predetermined driving paths imply less need of processing power when an autonomous vehicle navigates in the area. They also imply more efficient path planning, reducing the number of path options to a minimum which is required for conducting specific missions in the area, such as loading/unloading missions for the autonomous vehicles. According to example embodiments, predetermined driving paths may be adjusted, added and/or cancelled during operation of the vehicles in the area, such as adjusted in dependence on an adjusted topology of the area over time and/or a modified layout of the area over time.

Optionally, the predetermined driving paths comprise predetermined switching paths between the first and second driving behaviours, and/or vice versa. Accordingly, the autonomous vehicles may also navigate in the area by following the predetermined switching paths when required, i.e. when it is predicted that a meeting will occur.

Optionally, at least the second driving behaviours for the at least two vehicles are associated with respective predetermined driving paths in opposite directions along the road section, and the predetermined driving paths in opposite directions along the road section are at least partly overlapping driving paths so that a meeting of the at least two vehicles is not possible. According to one embodiment, the predetermined driving paths in opposite directions along the road section refer to the same driving path. This implies for example that the road section can be made narrower, thereby reducing the occupied space in the area which is used for the vehicles.

Optionally, the control system is further configured to determine a point in time and/or a position at which the at least one vehicle should initiate utilization of the first driving behaviour to thereby allow and/or facilitate for the vehicles to pass each other along the road section, wherein the point in time and/or the position is determined by comparing an estimated time period until the meeting will occur with a predetermined time period value. Still optionally, the predetermined time period value corresponds to a time period for switching between the second and the first driving behaviours. This implies that the switching between the driving behaviours can be optimized so that the second driving behaviour is used more frequently, without compromising with safety. More particularly, this implies that the switching between the driving behaviours can be performed as late as possible, without compromising with safety.

Preferably, the second driving behaviour is further associated with a higher driving speed in relation to the first driving behaviour. Accordingly, by using the second driving behaviour more frequently, productivity can be increased.

According to a second aspect of the invention, the object is at least partly achieved by an autonomous vehicle according to claim 17.

Hence, there is provided an autonomous vehicle which is adapted to travel autonomously along driving paths in an area, and wherein the autonomous vehicle is adapted to utilize a first and a second driving behaviour when driving along a driving path.

The first driving behaviour is associated with driving closer to an edge of a road section, in relation to the second driving behaviour, which is associated with driving further away from the edge and closer to a center line of the road section, and wherein the autonomous vehicle is further adapted to receive driving commands from a control system according to any one of the embodiments of the first aspect of the invention.

Advantages and effects of the second aspect are largely analogous to advantages and effects of the first aspect of the invention. It shall also be noted that any embodiment of the first aspect is combinable with any embodiment of the second aspect of the invention, and vice versa.

The autonomous vehicle preferably comprises one or more navigation sensors for navigating, or guiding, the vehicle in the area. For example, the navigation sensors may be any one of an environment perception sensor and a satellite navigation sensor. The environment perception sensor may for example be a LIDAR (Light Detection And Ranging) sensor, a RADAR (RAdio Detection And Ranging) sensor, an ultrasonic senor, a sonar (SOund Navigation And Ranging) sensor, a camera etc. The satellite navigation sensor may be a so called GNSS (Global Navigation Satellite System) sensor, such as a GPS (Global Positioning System) sensor.

Preferably, the autonomous vehicle is adapted to transmit data indicative of its driving status and position to the control system during driving. Additionally, or alternatively, other sensors associated with the area may be adapted to recognize data indicative of driving status and position of the autonomous vehicles.

According to a third aspect of the invention, the object is at least partly achieved by a method according to claim 19.

Hence, there is provided a method for controlling a fleet of autonomous vehicles which are adapted to travel along driving paths in an area, wherein the fleet of vehicles comprises at least two vehicles, each vehicle being adapted to utilize a first and a second driving behaviour when driving along a driving path.

The first driving behaviour is associated with driving closer to an edge of a road section, in relation to the second driving behaviour, which is associated with driving further away from the edge and closer to a center line of the road section.

The method comprises:
by use of data indicative of driving status and position of the at least two vehicles, predicting if a meeting between the at least two vehicles along the road section will occur, and
when it is predicted that the meeting will occur, commanding at least one, preferably each one, of the at least two vehicles to utilize the first driving behaviour to thereby allow and/or facilitate for the vehicles to pass each other along the road section.

Advantages and effects of the third aspect are largely analogous to advantages and effects of the first aspect of the invention. It shall also be noted that any embodiment of the first aspect is combinable with any embodiment of the third aspect of the invention, and vice versa.

Optionally, commanding at least one, preferably each one, of the at least two vehicles to utilize the first driving behaviour comprises commanding at least one, preferably each one, of the at least two vehicles to switch from utilizing the second driving behaviour to instead utilize the first driving behaviour.

Optionally, switching from utilizing the second driving behaviour to instead utilize the first driving behaviour is performed at any position along the road section.

Optionally, the method further comprises:
estimating a first required transition path along the road section for switching between the second driving behaviour to the first driving behaviour, wherein the first required transition path is estimated by use of a vehicle model which is based on physical properties of the at least one vehicle.

Optionally, switching from utilizing the second driving behaviour to instead utilize the first driving behaviour performed at a predetermined position along the road section.

Optionally, the method further comprises:
by use of the data indicative of driving status and position, determining when the meeting has occurred, and therefrom:
commanding the at least one, preferably each one, of the at least two vehicles to switch from utilizing the first driving behaviour to instead utilize the second driving behaviour.

Optionally, switching from utilizing the first driving behaviour to instead utilize the second driving behaviour is performed at any position along the road section.

Optionally, the method further comprises:
estimating a second required transition path along the road section for switching between the first driving behaviour to the second driving behaviour, wherein the second required transition path is estimated by use of a vehicle model which is based on the physical properties of the at least one vehicle.

Optionally, switching from utilizing the first driving behaviour to instead utilize the second driving behaviour is performed at a predetermined position along the road section.

Optionally, the method further comprises determining a point in time and/or a position at which the at least one vehicle should initiate utilization of the first driving behaviour to thereby allow and/or facilitate for the vehicles to pass each other along the road section, wherein the point in time and/or the position is determined by comparing an estimated time period until the meeting will occur with a predetermined time period value. Still optionally, the predetermined time period value corresponds to a time period for switching between the second and the first driving behaviours.

According to a fourth aspect of the invention, the object is at least partly achieved by a computer program according to claim 20. Hence, there is provided a computer program comprising program code means for performing the steps of the method according to any embodiment of the third aspect of the invention when said program is run on a computer.

According to a fifth aspect of the invention, the object is at least partly achieved by a computer readable medium according to claim 21. Hence, there is provided a computer readable medium carrying a computer program comprising program code means for performing the steps of the method according to any embodiment of the third aspect of the invention when said program product is run on a computer.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of an autonomous vehicle according to an example embodiment of the present invention,

FIG. 2 is a schematic view of a control system for controlling a fleet of autonomous vehicles according to an example embodiment of the present invention,

FIG. 3 is a schematic view of two autonomous vehicles which are switching driving behaviours according to an example embodiment of the present invention,

FIG. 4 is a schematic view of an autonomous vehicle which is switching driving behaviours according to an example embodiment of the present invention, and

FIG. 5 is a flowchart of a method according to an embodiment of the present invention.

### DETAILED DESCRIPTION OF EXAMPLE EMBODIMENTS OF THE INVENTION

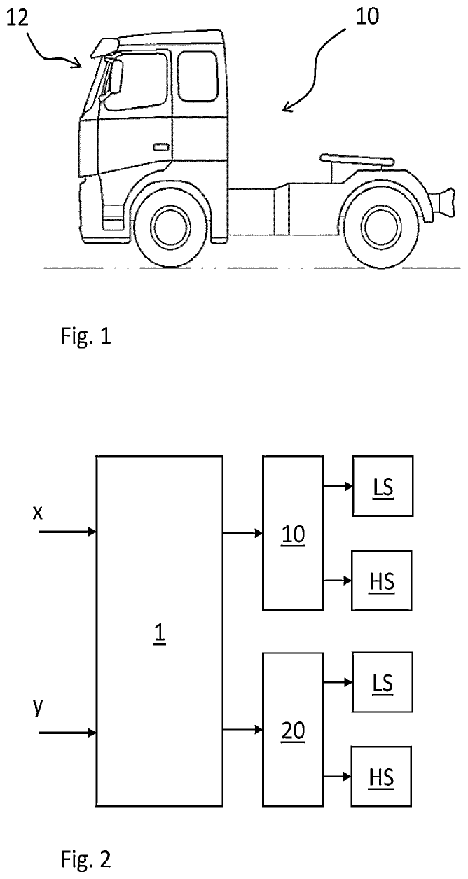

FIG. 1 depicts a side view of an autonomous vehicle 10 according to an example embodiment of the present invention. The vehicle 10 is herein a truck for towing one or more trailers (not shown). As can be seen, the vehicle 10 comprises a driver cabin 12 for a driver. Accordingly, the vehicle 10 as shown may selectively be driven autonomously or manually by a driver. For example, the driver may manually drive the vehicle 10 when it is driven in public road networks, and it may drive autonomously when it is driven in a confined area, such as a terminal area or a harbour area. Accordingly, the vehicle 10 can be adapted to at least drive autonomously as disclosed herein when the vehicle 10 is in a confined area, i.e. when not operating in a public road network. The invention is not limited to only this type of vehicle, but may advantageously be used for any other vehicle, such as buses, construction equipment and even passenger cars. However, the invention has shown to be particularly advantageous for vehicles driving autonomously in confined areas, such as mining areas, construction sites, the above-mentioned terminal area and harbour area, or any other confined area. In addition, even though a vehicle 10 with a driver cabin is shown, it shall be noted that the invention is also applicable to cabin-less autonomous vehicles, such as cabin-less dump trucks, wheel loaders, excavators, towing trucks etc.

FIG. 2 depicts a schematic view of a control system 1 for controlling a fleet of autonomous vehicles 10, 20, which are adapted to travel along driving paths HS, LS in an area.

The control system 1, indicated by a box, may be in the form of a computer, computer server, such as a central server, or the like, which is adapted to communicate with the autonomous vehicles 10, 20. Preferably, the communication between the control system 1 and the vehicles 10, 20 is performed by wireless communication, such as communication via WiFi, 3g, 4g, 5g or any other type of telecommunication. The control system 1 may comprise control logic, such as processing circuitry for processing data. It may further comprise one or more memories for storing data, including a computer program as disclosed herein, and also transmitting and receiving means for transmitting and receiving data to/from the vehicles 10, 20. The control system 1 may further comprise manual input means (not shown), such as a human machine interface (HMI) for receiving manual instructions and/or for informing an operator about status of the fleet of autonomous vehicles 10, 20. For example, an operator may manually instruct one or more of the autonomous vehicles 10, 20 of the fleet to carry out certain missions, such as loading and/or unloading missions. The operator may additionally or alternatively provide a “wake-up” instruction to activate one or more of the autonomous vehicles 10, 20, and/or a deactivation instruction to deactivate one or more of the autonomous vehicles 10, 20. The deactivation instruction may comprise an instruction for the vehicle 10, 20 to drive autonomously to a parking spot in the area.

The control system 1 may be located in the area, such as in a command central (not shown) of the area. Additionally, or alternatively, the control system 1 may be located in a remote location from the area, such as the control system is part of a cloud-based system and/or in a remote command central, such as a remote command central which is adapted to operate fleets of vehicles operating in a plurality of different areas.

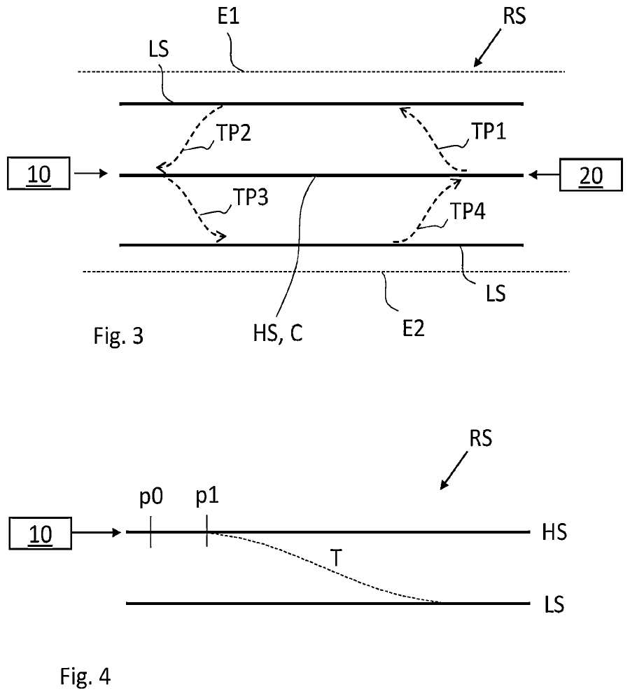

The fleet of vehicles comprises at least two vehicles 10, 20. Each vehicle 10, 20 is adapted to utilize a first and a second driving behaviour HS, LS when driving along a driving path. The first driving behaviour LS is associated with driving closer to an edge E1, E2 of a road section RS, in relation to the second driving behaviour HS, which is associated with driving further away from the edge E1, E2 and closer to a center line C of the road section RS. A schematic example of a road section RS is shown in FIG. 3. The edges E1 and E2 of the road section RS are edges on opposite sides of the center line C. As indicated in FIG. 2 by arrows to respective boxes, each vehicle 10, 20 can utilize either the first driving behaviour LS or the second driving behaviour HS.

The control system 1 is configured to:
by use of data indicative of driving status x and position y of the at least two vehicles 10, 20, predict if a meeting between the at least two vehicles 10, 20 along the road section RS will occur, and
when it is predicted that the meeting will occur, command at least one, preferably each one, of the at least two vehicles 10, 20 to utilize the first driving behaviour LS to thereby allow and/or facilitate for the vehicles 10, 20 to pass each other along the road section RS.

The commanding of at least one, preferably each one, of the at least two vehicles 10, 20 is indicated in FIG. 2 by the arrows between the control system 1 and the vehicles 10, 20.

As mentioned in the above, this is preferably performed by wireless communication means.

The driving status data x may typically comprise information indicative of vehicle speed, and the data indicative of position y may typically comprise map data of the area.

Furthermore, the first and second driving behaviours LS, HS are preferably predefined for each respective vehicle. For example, each vehicle 10, 20 may comprise a respective control unit (not shown) which is configured to drive the respective vehicle autonomously according to the first and the second predefined driving behaviours LS, HS. Accordingly, each respective control unit of the respective vehicle 10, 20 may be configured to issue control signals to one or more actuators (not shown) which are adapted to control vehicle motion, i.e. at least one of propulsion force, braking force and steering.

The driving status data x may comprise further status information, such as vehicle weight, type of load, if the vehicle is loaded or unloaded, type of mission etc. Such data may be used for selecting which one of the first and second driving behaviours LS, HS a vehicle 10, 20 should utilize.

FIG. 3 depicts a schematic view when each one of the at least two vehicles 10, 20 are commanded to utilize the first driving behaviour LS to thereby allow and/or facilitate for the vehicles 10, 20 to pass each other along the road section RS. The first driving behaviour LS is shown as respective lines next to the edges E1, E2. The lines represent driving paths for the vehicles 10, 20. The line HS, C in FIG. 3 represents the driving paths for the vehicles 10, 20 when utilizing the second driving behaviour HS. As shown, the vehicles 10, 20 are initially driving in opposite directions towards each other at the center C of the road section RS. Accordingly, at this point in time, each vehicle 10, 20 is utilizing the second driving behaviour HS. When it has been predicted that the meeting will occur, each vehicle 10, 20 is commanded to utilize the first driving behaviour LS instead. This is indicated by the dashed arrows TP1, TP3 in the figure which are directed from the center C of the road section RS towards the respective edges E1, E2 of the road section RS.

When the vehicles 10, 20 are driving in opposite directions in the road section RS as show in e.g. FIG. 3, the switching from the second to the first driving behaviour for each vehicle 10, 20 is configured so that both vehicles 10, 20 are either making a left turn or a right turn, as seen in the travel direction of each vehicle 10, 20. Thereby, the vehicles 10, 20 can safely pass each other and avoid a collision. On the other hand, in the event the vehicles 10, 20 are driving in the same direction in the road section RS, the switching from the second to the first driving behaviour for each vehicle is preferably configured so that one of the vehicles is making a left turn and the other vehicle is making a right turn, as seen in the travel direction of each vehicle. Thereby, the vehicles can safely pass by each other and avoid a collision.

The switching from utilizing the second driving behaviour HS to instead utilize the first driving behaviour LS may be configured to be performed at any position along the road section RS.

The control system 1 may further be configured to estimate a first required transition path TP1, TP3 along the road section RS for switching between the second driving behaviour HS to the first driving behaviour LS, wherein the first required transition path TP1, TP3 is estimated by use of a vehicle model which is based on physical properties of the at least one vehicle 10, 20. For example, based on information about vehicle weight, wheelbase, number of articulation joints etc, a vehicle model may be used to estimate the minimum required transition path TP1, TP3 for switching between the driving behaviours LS, HS, without compromising with safety. An example of a vehicle model is the so-called bicycle model. Another example of a vehicle model that can be used for this purpose is the so-called Ackermann model.

According to an example embodiment, switching from any one of the driving behaviours to the other driving behaviour may be denoted as performing a lane change or path change.

Alternatively, switching from utilizing the second driving behaviour HS to instead utilize the first driving behaviour LS may be configured to be performed at a predetermined position along the road section RS.

With reference to FIG. 3, the control system 1 may further be configured to:
by use of the data indicative of driving status and position, determine when the meeting has occurred, and therefrom:
command the at least one, preferably each one, of the at least two vehicles 10, 20 to switch from utilizing the first driving behaviour LS to instead utilize the second driving behaviour HS.

This is indicated by the dashed arrows TP2, TP4 in the figure which are directed from each respective driving path LS associated with the respective edges E1, E2 to the center line C of the road section RS.

The switching from utilizing the first driving behaviour LS to instead utilize the second driving behaviour HS may be configured to be performed at any position along the road section RS.

As shown, the control system 1 may further be configured to estimate a second required transition path TP2, TP4 along the road section RS for switching between the first driving behaviour LS to the second driving behaviour HS, wherein the second required transition path TP2, TP4 is estimated by use of a vehicle model which is based on the physical properties of the at least one vehicle 20. The vehicle model may be the same vehicle model used for estimating the first required transition path TP1, TP3.

Alternatively, switching from utilizing the first driving behaviour LS to instead utilize the second driving behaviour HS may be configured to be performed at a predetermined position along the road section RS.

The second driving behavior HS for at least one, preferably each one, of the at least two vehicles 10, 20 is a default driving behaviour. Accordingly, the vehicles 10, 20 may most often utilize the second driving behaviour HS when the vehicles 10, 20 are driving closer to the center C of the road section RS.

At least one of the first LS and second HS driving behaviours is associated with predetermined driving paths in the area, e.g. as shown in FIG. 3.

The predetermined driving paths HS, LS may comprise predetermined switching paths between the first LS and second HS driving behaviours, and/or vice versa. Accordingly, the paths TP1, TP2, TP3, TP4 as shown in FIG. 3 may be predetermined switching paths.

At least the second driving behaviours HS for the at least two vehicles 10, 20 may be associated with respective predetermined driving paths in opposite directions along the road section RS, and the predetermined driving paths in opposite directions along the road section RS may be at least partly overlapping driving paths so that a meeting of the at least two vehicles 10, 20 is not possible. This situation is shown in FIG. 3.

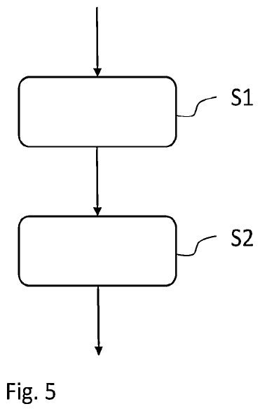

With reference to FIG. 4, the control system 1 may further be configured to determine a point in time and/or a position p0 at which the at least one vehicle 10 should initiate utilization of the first driving behaviour LS to thereby allow and/or facilitate for the vehicles 10, 20 to pass each other along the road section RS, wherein the point in time and/or the position p0 is determined by comparing an estimated time period until the meeting will occur with a predetermined time period value T. In the shown embodiment, the predetermined time period value T corresponds to a time period for switching between the second HS and the first LS driving behaviours.

In the shown embodiment, p1 is a position where the actual transition from the second driving behaviour to the first driving behaviour begins. This position may be a predefined transition position. At this position p1, the vehicle 10 may be required to have a predetermined speed which allows the vehicle to safely switch between the driving behaviours.

The position p0 at which the at least one vehicle 10 should initiate utilization of the first driving behaviour LS may for example be a position where the vehicle 10 is starting to slow down its speed so that it will have the predetermined speed when reaching the position p1. In order to determine the position p0, information about any one of the current weight of the vehicle, current road friction, braking capability etc. may be used.

Accordingly, by this information it may be determined how long distance is required for braking the vehicle 10 so that it attains the predetermined speed at the position p1. Additionally, or alternatively, other information that may be used for determining the position p0 is map data, such as information about road inclination, road curvature etc. The current road friction may be estimated by the vehicle 10 and/or it may be provided by the control system 1, e.g. it may be predetermined for the area and/or the road section RS.

The second driving behaviour HS is preferably associated with a higher driving speed in relation to the first driving behaviour LS.

FIG. 5 depicts an embodiment of a method according to an example embodiment of the invention.

The method controls a fleet of autonomous vehicles 10, 20 which are adapted to travel along driving paths HS, LS in an area, wherein the fleet of vehicles comprises at least two vehicles 10, 20, each vehicle being adapted to utilize a first and a second driving behaviour LS, HS when driving along a driving path LS, HS.

The first driving behaviour LS is associated with driving closer to an edge E1, E2 of a road section RS, in relation to the second driving behaviour HS, which is associated with driving further away from the edge E1, E2 and closer to a center line C of the road section RS.

The method comprises:
S1: by use of data indicative of driving status and position of the at least two vehicles 10, 20, predicting if a meeting between the at least two vehicles 10, 20 along the road section RS will occur, and
S2: when it is predicted that the meeting will occur, commanding at least one, preferably each one, of the at least two vehicles 10, 20 to utilize the first driving behaviour LS to thereby allow and/or facilitate for the vehicles 10, 20 to pass each other along the road section.

The method may comprise further optional steps as disclosed herein. The method may be implemented as a computer program as disclosed herein and/or it may be provided in a computer readable medium as disclosed herein.

It is to be understood that the present invention is not limited to the embodiments described above and illustrated in the drawings; rather, the skilled person will recognize that many changes and modifications may be made within the scope of the appended claims.

1. A control system for controlling a fleet of autonomous vehicles which are adapted to travel along driving paths in an area,
wherein the fleet of vehicles comprises at least two vehicles, each vehicle being adapted to utilize a first and a second driving behaviour when driving along a driving path, wherein,
the first driving behaviour is associated with driving closer to an edge of a road section, in relation to the second driving behaviour, which is associated with driving further away from the edge and closer to a center line of the road section,
wherein the control system is configured to:
by use of data indicative of driving status and position of the at least two vehicles, predict if a meeting between the at least two vehicles along the road section will occur, and
when it is predicted that the meeting will occur, command at least one, preferably each one, of the at least two vehicles to utilize the first driving behaviour to thereby allow and/or facilitate for the vehicles to pass each other along the road section.

2. The control system according to claim 1, wherein commanding at least one of the at least two vehicles to utilize the first driving behaviour comprises commanding at least one of the at least two vehicles to switch from utilizing the second driving behaviour to instead utilize the first driving behaviour.

3. The control system according to claim 2, wherein switching from utilizing the second driving behaviour to instead utilize the first driving behaviour is configured to be performed at any position along the road section.

4. The control system according to claim 3, further configured to:
estimate a first required transition path along the road section for switching between the second driving behaviour to the first driving behaviour, wherein the first required transition path is estimated by use of a vehicle model which is based on physical properties of the at least one vehicle.

5. The control system according to claim 2, wherein switching from utilizing the second driving behaviour to instead utilize the first driving behaviour is configured to be performed at a predetermined position along the road section.

6. The control system according to claim 1, further configured to:
by use of the data indicative of driving status and position, determine when the meeting has occurred, and therefrom:
command the at least one the at least two vehicles to switch from utilizing the first driving behaviour to instead utilize the second driving behaviour.

7. The control system according to claim 6, wherein switching from utilizing the first driving behaviour to instead utilize the second driving behaviour is configured to be performed at any position along the road section.

8. The control system according to claim 7, further configured to:
estimate a second required transition path along the road section for switching between the first driving behaviour to the second driving behaviour, wherein the second required transition path is estimated by use of a vehicle model which is based on the physical properties of the at least one vehicle.

9. The control system according to claim 6, wherein switching from utilizing the first driving behaviour to instead utilize the second driving behaviour is configured to be performed at a predetermined position along the road section.

10. The control system according to claim 1, wherein the second driving behavior for at least one of the at least two vehicles is a default driving behaviour.

11. The control system according to claim 1, wherein at least one of the first and second driving behaviours is associated with predetermined driving paths in the area.

12. The control system according to claim 11, wherein the predetermined driving paths comprise predetermined switching paths between the first and second driving behaviours, and/or vice versa.

13. The control system according to claim 11, wherein at least the second driving behaviours for the at least two vehicles are associated with respective predetermined driving paths in opposite directions along the road section, and wherein the predetermined driving paths in opposite directions along the road section are at least partly overlapping driving paths so that a meeting of the at least two vehicles is not possible.

14. The control system according to claim 1, further configured to determine a point in time and/or a position at which the at least one vehicle should initiate utilization of the first driving behaviour to thereby allow and/or facilitate for the vehicles to pass each other along the road section, wherein the point in time and/or the position is determined by comparing an estimated time period until the meeting will occur with a predetermined time period value.

15. The control system according to claim 14, wherein the predetermined time period value corresponds to a time period for switching between the second and the first driving behaviours.

16. The control system according to claim 1, wherein the second driving behaviour is further associated with a higher driving speed in relation to the first driving behaviour.

17. An autonomous vehicle which is adapted to travel autonomously along driving paths in an area, and wherein the autonomous vehicle is adapted to utilize a first and a second driving behaviour when driving along a driving path, wherein the first driving behaviour is associated with driving closer to an edge of a road section, in relation to the second driving behaviour, which is associated with driving further away from the edge and closer to a center line of the road section, and wherein the autonomous vehicle is further adapted to receive driving commands from a control system according to claim 1.

18. The autonomous vehicle according to claim 17, further adapted to transmit data indicative of its driving status and position to the control system during driving.

19. A method for controlling a fleet of autonomous vehicles which are adapted to travel along driving paths in an area,
wherein the fleet of vehicles comprises at least two vehicles, each vehicle being adapted to utilize a first and a second driving behaviour when driving along a driving path, wherein,
the first driving behaviour is associated with driving closer to an edge of a road section, in relation to the second driving behaviour, which is associated with driving further away from the edge and closer to a center line of the road section,
wherein the method comprises:
by use of data indicative of driving status and position of the at least two vehicles, predicting if a meeting between the at least two vehicles along the road section will occur, and
when it is predicted that the meeting will occur, commanding at least one of the at least two vehicles to utilize the first driving behaviour to thereby allow and/or facilitate for the vehicles to pass each other along the road section.

20. A computer program comprising program code means for performing the steps of claim 19 when said program is run on a computer.

21. A non-transitory computer readable medium carrying a computer program comprising program code for performing the steps of claim 19 when said program code is run on a computer.
